(19) United States
(12) Patent Application Publication
(10) Pub. No.: US 2002/0057795 A1
(43) Pub. Date: May 16, 2002

(54) Content protection through the audio and video decrypting and decoding device

(76) Inventors: Jeffrey Jonathan Spurgat, Madison, WI (US); Stephen Christopher Gladwin, Chicago, IL (US); Depeng Bi, Algonquin, IL (US); Troy Steven Denkinger, Chicago, IL (US)

Correspondence Address: John S. Paniaguas, KATTEN MUCHIN ZAVIS, Suite 1600, 525 West Monroe Street, Chicago, IL, 60661, US

(21) Appl. No.: 09/833,173

(22) Filed: Apr. 11, 2001

Related U.S. Application Data
(60) Provisional application No. 60/247,318, filed on Nov. 10, 2000.

(51) Int. Cl. H04K 3/00

(52) U.S. Cl. 380/1

(57) ABSTRACT

A secure platform in which the decrypting or decoding of secure audio or video data is done on a peripheral device of the computing platform, thus preventing software applications and drivers running on the computing platform from having access to the digital audio or video data after it has been decrypted or decoded. The unprotected digital audio or video data may then be converted from a digital format into an analog format before leaving the peripheral device, thus making exact digital reproduction no longer possible due to the inherent degradation of audio or video quality in the conversion process from digital to analog and then back to digital.

### CROSS-REFERENCE TO RELATED APPLICATIONS

This application claims priority of commonly-owned co-pending provisional patent application entitled: “Content Protection Through the Audio and Video Decrypting and Decoding Device,” by Spurgat, et al., Ser. No. 60/247,318, filed on Nov. 10, 2000.

### BACKGROUND OF THE INVENTION

1. Field of the Invention

The present invention relates to secure a computing platform for protecting encoded or encrypted data, for example, digital audio or video files.

2. Description of the Prior Art

Software based audio or video decrypting and decoding schemes running on general purpose or open fixed function computing platforms are inherently insecure in maintaining copy protection and data security for encrypted or encoded digital audio or video data. This content protection security hole exists due to the nature of the layered architecture of computing platform operating systems that allows digital audio or video data that has been decrypted or decoded to be intercepted by various software applications and drivers and then to be redirected for saving in an unprotected format. The now unprotected digital audio or video data can then be openly redistributed, thus easily overcoming the copy protection that the encrypting or encoding was supposed to provide and thereby allowing exact digital copies to be made of the digital audio or video data.

This problem is illustrated in FIGS. 1 and 2. More particularly, FIGS. 1 and 2 illustrate the architecture of known computing platforms. FIG. 1 provides a general overview of software based audio or video decrypting or decoding on a known computing platform 100. For software based audio or video decrypting or decoding, as well as with the secure peripheral scheme, networked computers or servers 121 can provide streamed encrypted or encoded audio or video data 131 or stored encrypted or encoded audio or video data 132 through the Internet or other network 120 to an audio or video playback application 141 running on a computing platform 100. In addition, the audio or digital playback application 141 can receive local encrypted or encoded audio or video data 130 from local storage 103 on the computing platform 100. Next, the software based audio or video decrypting or decoding by the audio or video playback application 141 is responsible for generating the decrypted or decoded audio or video data 134. Normally, the decrypted or decoded audio or video data 134 is then passed to audio or video playback hardware 110 where the decrypted or decoded audio or video data 134 is converted to analog audio or video 135. The analog audio or video 135 is then made available for access outside the computing platform 100. However, due to the layered and open nature of operating systems on computing platforms 100, described later in more detail, audio or video data capture applications 147 are able to intercept and redirect the decrypted or decoded audio or video data 134. The audio or video data capture application 147 can then save the decrypted or decoded audio or video data 134 in local storage 103 on the computing platform 100 as unprotected audio or video data 136. Once saved, the unprotected audio or video data 136 can be freely redistributed since the copy protection and security provided by the encryption and encoding have been successfully circumvented.

FIG. 2 illustrates the data flow during software based audio or video playback on an open computing platform 100. In this application an audio or video playback application 141 running on a computing platform 100 receives streamed encrypted or encoded audio or video data 131 or stored encrypted or encoded audio or video data 132 from networked computers or servers 121 through the Internet or other network 120. A network interface or modem 108 on the computing platform 100, along with networking interface software 144, support data transfer from the Internet or other network 120 to the audio or video playback application 141. The audio or video playback application 141 receives local encrypted or encoded audio or video data 130 from local storage 103 on the computing platform 100. The file system and storage interface software 145 supports data transfer from local storage 103 to the audio or video playback application 141. Once the encrypted or encoded audio or video data 133 is available to the audio or video playback application 141, it may be temporarily buffered to prevent overflow or underflow by audio or video data handling and control software 142 within the audio or video playback application 141. The encrypted or encoded audio or video data 133 is then passed to the decryption or decode software 143, also within the audio or video playback application 141, for decrypting or decoding. Once this is complete, the decrypted or decoded audio or video data 134 is unprotected. Normally, the decrypted or decoded audio or video data 134 is passed to the audio or video data playback driver 148 to be converted to analog audio or video 135 by the audio or video playback hardware 110. However, an audio or video data intercept driver or application 146 can be written that either replaces the audio or video data playback driver 148 or is simply placed in the data path between the decryption and decode software 143 and the audio or video data playback driver 148, depending on the implementation specifics of the operating system architecture. The audio or video data intercept driver or application 146 can then redirect the decrypted or decoded audio or video data 134 to an audio or video data capture application 147 where it can be saved as unprotected audio or video data 136 in local storage 103. Once there, the unprotected audio or video data 136 can easily be copied and redistributed, thus circumventing the security and protection originally provided by the encrypting or encoding of the audio or video data.

Thus, there is a need for a secure platform for protecting encoded or encrypted data, such as audio and video or data files.

### SUMMARY OF THE INVENTION

Briefly, the present invention relates to a secure platform in which the decrypting or decoding of secure audio or video data is done on a peripheral device of the computing platform, thus preventing software applications and drivers running on the computing platform from having access to the digital audio or video data after it has been decrypted or decoded. The unprotected digital audio or video data may then be converted from a digital format into an analog format before leaving the peripheral device, thus making exact digital reproduction no longer possible due to the inherent degradation of audio or video quality in the conversion process from digital to analog and then back to digital.

### BRIEF DESCRIPTION OF THE DRAWINGS

These and other advantages of the present invention will be readily apparent from the following specification and drawing wherein:

FIG. 1 is a block diagram illustrating known software audio or video decrypting or decoding.

FIG. 2 is a block diagram illustrating the software layering and data flow in known systems.

FIG. 3 is a block diagram of a secure peripheral audio or video decrypting or decoding platform in accordance with the present invention.

FIG. 4 is a block diagram of a secure peripheral architecture in accordance with the present invention.

FIG. 5 is a block diagram of the computing platform which forms a portion of the present invention, shown connected to a plurality of external devices.

FIG. 6 is a software flow diagram for the audio or video playback application in accordance with the present invention.

FIG. 7 is a software flow diagram of the peripheral bus interface firmware in accordance with the present invention.

FIG. 8 is a software flow diagram of the audio or video processor firmware in accordance with the present invention.

FIGS. 9-11 are schematic diagrams of the secure peripheral in accordance with the present invention.

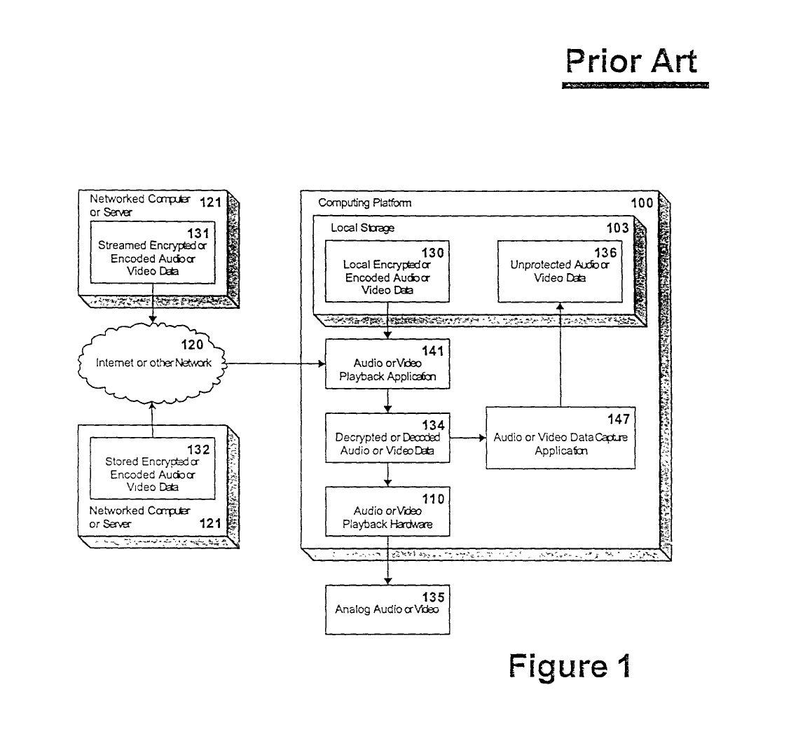

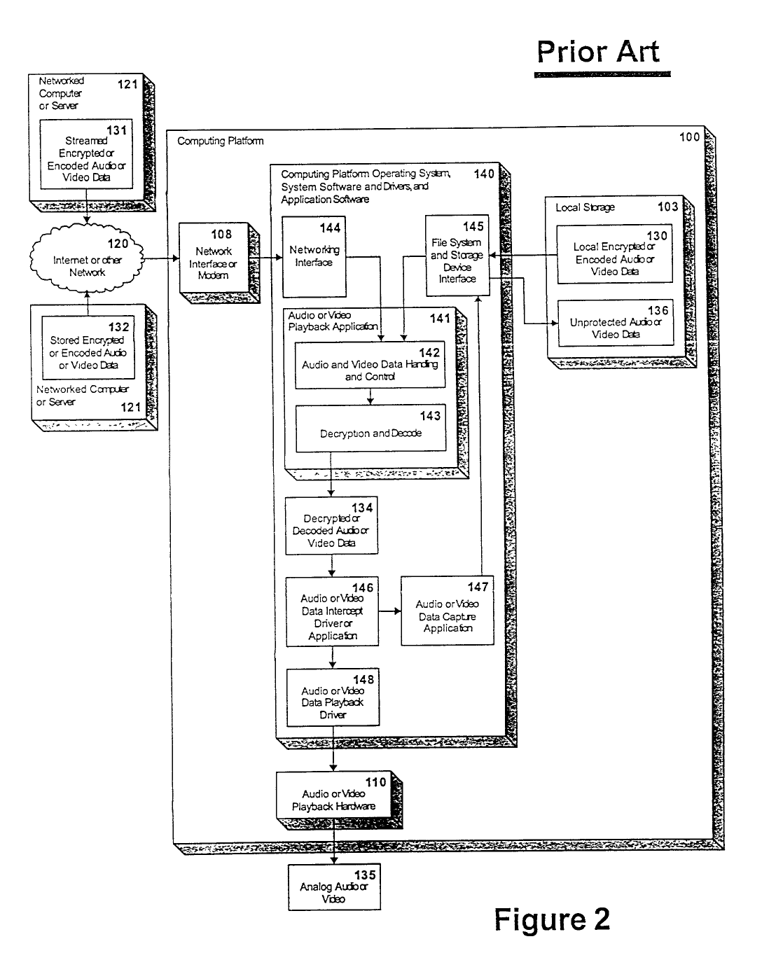

### DETAILED DESCRIPTION

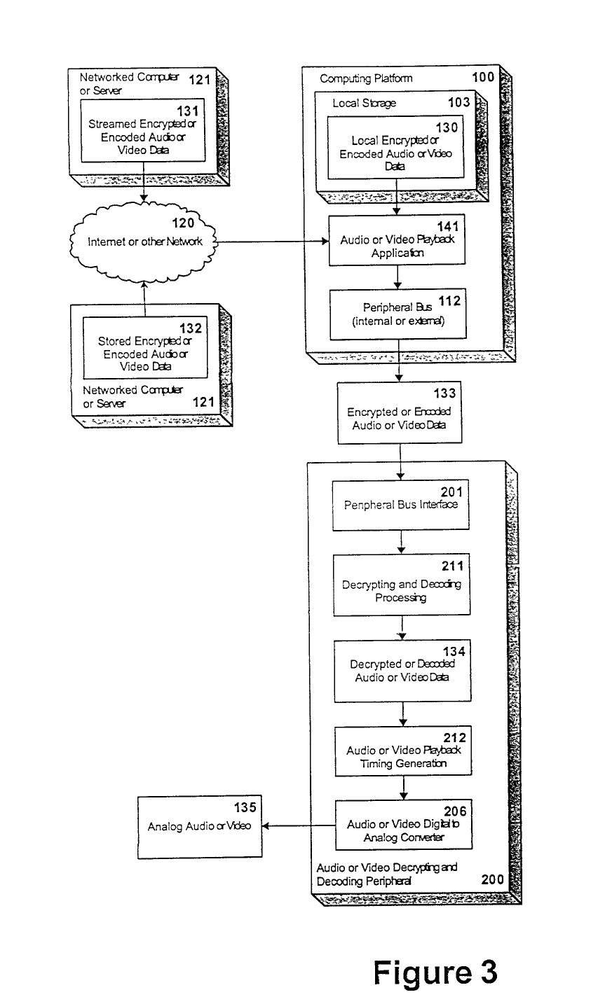

The present invention is adopted to maintain copy protection and security of digital audio and video data throughout the playback process, including the conversion to analog format, through the use of an audio or video decrypting and decoding peripheral 200 connected to a computing platform 100 as shown in FIG. 3. This system is adapted to be used in conjunction with the system disclosed in, for example, commonly owned copending applications, Ser. No. 09/649,981, filed on Aug. 29, 2000 and Ser. No. 09/709,772, filed on Nov. 8, 2000, both entitled, “Structure and Method for Selecting, Controlling and Sending Internet based or Local Digital Audio to an AM/FM Radio or Analog Amplifier”, both hereby incorporating by reference.

The computing platform 100, described later in more detail, can encompass anything from general-purpose devices, such as personal computers, to open fixed function devices, such as set-top boxes or Internet appliances. As shown in FIG. 3, networked computers or servers 121 can provide streamed encrypted or encoded audio or video data 131 or stored encrypted or encoded audio or video data 132 through the Internet or other network 120 to an audio or video playback application 141, for example, Microsoft Windows Media Player running on the computing platform 100. Alternatively, the audio or video playback application 141 can receive local encrypted or encoded audio or video data 130 from a local storage device 103 on the computing platform 100. The encrypted or encoded audio or video data 133 is then passed by the audio or video playback application 141 to an audio or video decrypting and decoding peripheral 200 in accordance with the present invention by way of a peripheral bus 112, for example, as discussed below, on the computing platform 100, on the audio or video decrypting and decoding peripheral 200. The peripheral bus interface 201, for example Texas Instruments Model No. TUSB3200, receives the encrypted or encoded audio or video data 133 from the computing platform 100. The encrypted or encoded audio or video data 133 then goes through decrypting and decoding processing 211 where the encrypted or encoded audio or video data 133 is decrypted or decoded as the data is received from the computing platform 100. At this point, the decrypted or decoded audio or video data 134 is protected and secure since audio or video data capture applications 147 running on the computing platform 100 are prevented by the audio or video decrypting and decoding peripheral 200 from intercepting and redirecting the decrypted or decoded audio or video data 134.

The decrypted or decoded audio or video data 134 then passes through the audio or video playback timing generation 212, where the decrypted or decoded audio or video data 134 is synchronized for playback. The decrypted or decoded audio or video data 134 may be converted to analog audio or video 135 by the audio or video digital to analog converter 206. The analog audio or video 135 may be made available for access outside the audio or video decrypting and decoding peripheral 200. With a configuration as described in the present invention, copy protection and security are maintained since the process of decryption and decode is moved from the computing platform 100 to the audio or video decrypting and decoding peripheral 200, where access to decrypted or decoded audio or video data 134 by audio or video data capture applications 147 running on the computing platform 100 is not available.

Secure Peripheral Architecture

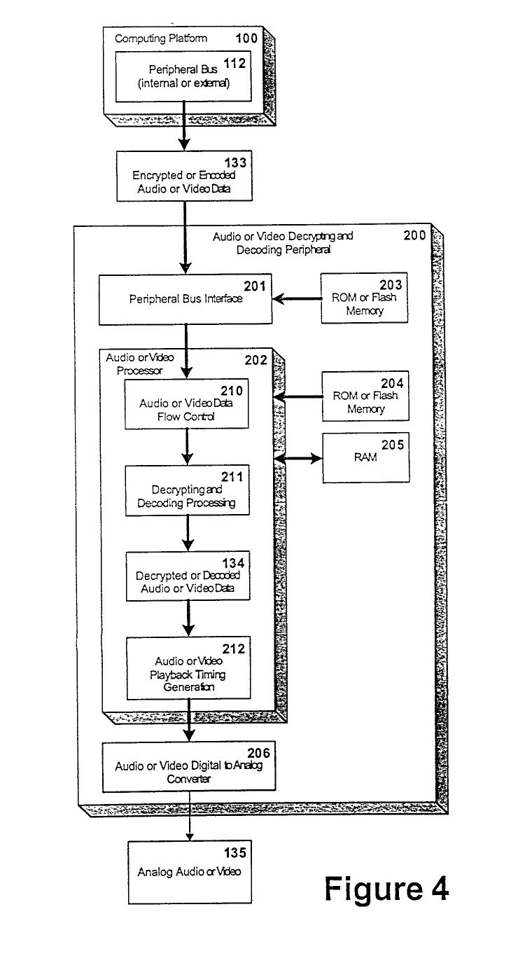

An audio or video decrypting and decoding peripheral 200 provides secure decrypting or decoding of encrypted or encoded audio or video data 133 by moving the process of decrypting and decoding from decryption or decode software 143 running on the computing platform 100 to the audio or video decrypting and decoding peripheral 200 itself. In this configuration, an audio or video data capture application 147 running on the computing platform 100 is no longer able to intercept and redirect the decrypted or decoded audio or video data 134 since the decrypted or decoded audio or video data 134 on the audio or video decrypting and decoding peripheral 200 is not accessible by the audio or video data capture application 147. As shown in FIG. 4, the audio or video decrypting and decoding peripheral 200 connects to the computing platform 100 through a peripheral bus 112 on the computing platform 100, such as Universal Serial Bus, commonly referred to as USB, IEEE 1394, commonly referred to as FireWire, and Peripheral Connect Interface, commonly referred to as PCI. Encrypted or encoded audio or video data 133 is streamed to the audio or video decrypting and decoding peripheral 200 by the computing platform 100, whether or not the data is also being streamed to the computing platform 100 or was already stored on the computing platform 100 or on a networked computer or server 121. The peripheral bus interface 201 on the audio or video decrypting and decoding peripheral 200 receives the encrypted or encoded audio or video data 133 from the computing platform 100 and passes the encrypted or encoded audio or video data 133 to an audio or video processor 202, for example, a Texas Instrument Model No. TMS320VC5416. The audio or video processor 202 handles audio or video data flow control 210 to ensure that there is no overflow or underflow of the encrypted or encoded audio or video data 133. Next, the audio or video processor 202 does decrypting and decoding processing 211 on the encrypted or encoded audio or video data 133 to generate decrypted or decoded audio or video data 134 for example utilizing conventional commercially available decoding or decrypting software, such as the Microsoft Windows Media audio decoder.

At this point, the decrypted or decoded audio or video data 134 is in an unprotected format, though it is still secure since it is inaccessible external to the audio or video decrypting and decoding peripheral 200. Next, the audio or video processor 202 handles audio or video playback timing generation 212 so that the decrypted or decoded audio or video data 134 is properly synchronized for playback. The audio or video processor 202 then passes the decrypted or decoded audio or video data 134 to an audio or video digital to analog converter 206, where the decrypted or decoded digital audio or video data 134 is converted to analog audio or video 135. The analog audio or video 135 is then made available external to the audio or video decrypting and decoding peripheral 200 for listening, such as on speakers or a stereo, or for viewing, such as on a TV or monitor. The audio or video decrypting and decoding peripheral 200 may buffer small amounts of encrypted or encoded audio or video data 133 during real-time playback processing, but it does not persistently store the encrypted or encoded audio or video data 133 for future playback.

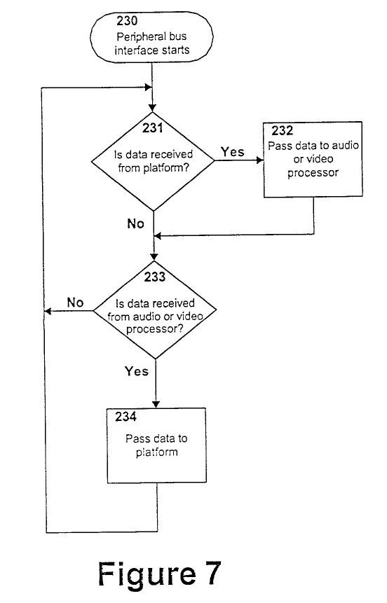

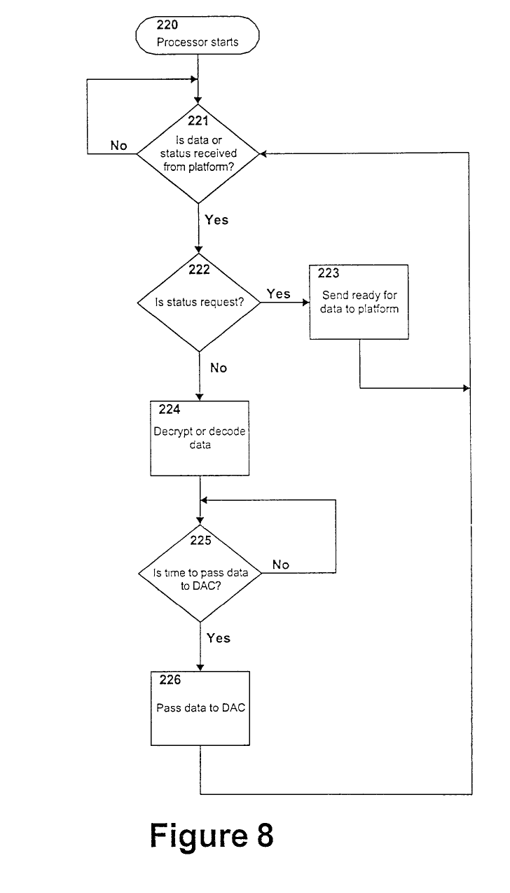

The firmware, for example, as illustrated in FIG. 7, run by the peripheral bus interface 201 typically comes from a read only memory, or ROM, or flash memory 203. The firmware for the audio or video processor 202 for example, as illustrated in FIG. 8 may be stored in a ROM or flash memory 204. External random access memory 205, or RAM, may be used by the audio or video processor 202 for audio or video data buffering, among other things. Additional firmware may also be downloaded from the computing platform 100 through the peripheral bus 112 for immediate use by the audio or video processor 202.

Computing Platform

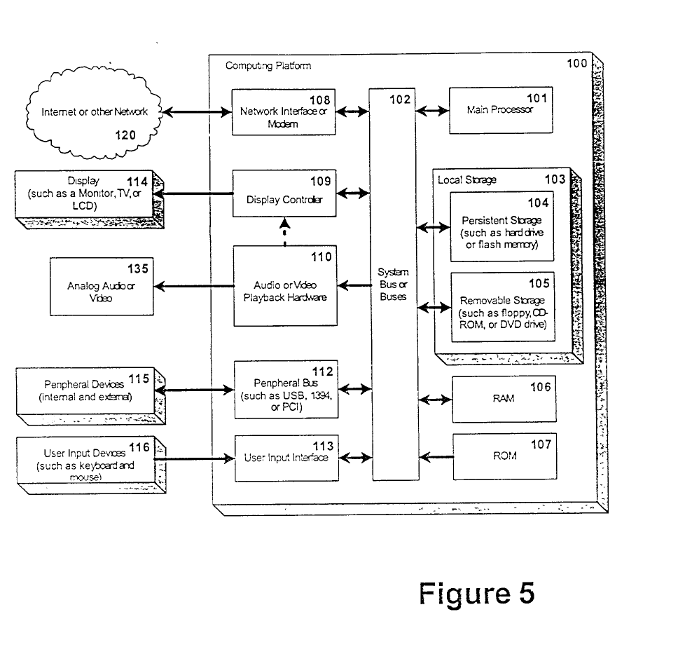

FIG. 5 illustrates typical system architecture of a computing platform 100, which can encompass anything from general-purpose devices, such as personal computers, to open fixed function devices, such as set-top boxes or Internet appliances. In general, the computing platform 100 has a main processor 101 for example, a Pentium III, microprocessor, for executing the operating system, for example, Microsoft Windows 98 operating system, system software and drivers, and application software 140, referred to as software instructions 140. These various software instructions 140 are typically stored in read only memory or ROM 107, or local storage 103. The local storage 103 can consist of persistent storage 104, such as hard drives or flash memory, or removable storage 105, such as floppy drives, CD-ROM drives, or DVD drives. The software instructions 140 may be executed by the main processor 101 directly from their storage location or loaded into random access memory 106, or RAM, to be executed from RAM 106 by the main processor 101. Other information stored in local storage 103 can be local encrypted or encoded audio or video data 130.

The computing platform 100 may use a network interface or modem 108 to access networked computers or servers 121 on the Internet or other a network 120, in order to download stored encrypted or encoded audio or video data 132 or to receive streamed encrypted or encoded audio or video data 131. The network interface or modem 108 is connected internally or externally using either a system bus 102 or peripheral bus 112. A peripheral bus 112 is provided for connecting internal and external peripheral devices 115 to the computing platform 100 in a standard manner. Suitable peripheral buses 112 include; Universal Serial Bus, commonly referred to as USB, IEEE 1394 bus, commonly referred to as FireWire, and Peripheral Connect Interface, commonly referred to as a PCI bus. The computing platform 100 may also be configured to support connection through a user input interface 113 to external or integrated user input devices 116, such as keyboards and mice. For output to the user, the computing platform 100 contains a display controller 109, for example, an NVIDIA Model No. GeForce2, which stores graphical data, such as windows, bitmaps and text. The display controller 109 outputs the graphical data in a format that is displayed to the user on a display 114, such as a video monitor, television, or LCD panel. In addition to display output, the computing platform 100 can provide separate analog audio or video output 135, which is provided by audio or video playback hardware 110, for example, a Creative Lab, Sound Blaster AWE64. The audio or video playback hardware 110 typically provides some level of hardware or software audio or video processing as well as conversion of decrypted or decoded audio or video data 134 to analog audio or video 135 for connection to audio output devices, such as speakers, headphones, or a stereo or to video output devices such as a TV. The video can also be passed to the display controller 109 to be merged with the graphical data. The description of a computing platform 100 is not limited to the capabilities and features listed, but may contain a subset of the described features or may contain additional capabilities or features not listed.

Audio or Video Playback Application Software Flow

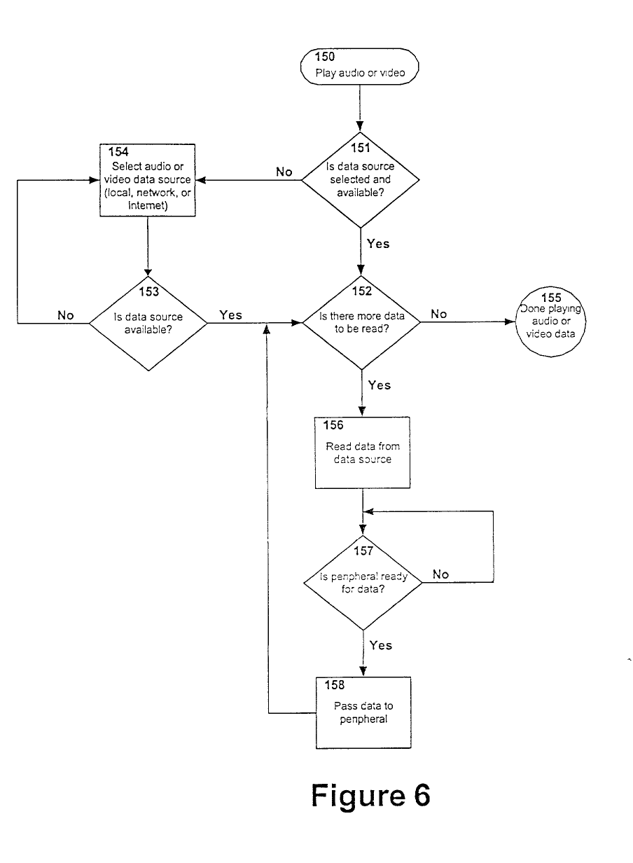

FIG. 6 is a software flow diagram for the audio or video playback application 141 for use with the present invention where an audio or video decrypting and decoding peripheral 200 is used. The first step in audio or video playback software flow for the audio or video playback application 141 is that a play audio or video command 150 is initiated either automatically by some process or through user interaction. Once the play audio or video command 150 is initiated, the audio or video playback application 141 determines if there is a data source selected and available in step 151. If the data source is not selected or is not available, the system awaits selection of the audio or video data source in step 154. The selection may be controlled by the process that initiated the play audio or video command 150 or by the user. The audio or video data source can be local encrypted or encoded audio or video data 130 kept in local storage 103 on the computing platform 100 where the audio or video playback application 141 is running. The audio or video data source may also be streamed encrypted or encoded audio or video data 131 or stored encrypted or encoded audio or video data 132 from a networked computer or server 121 and accessed by the audio or video playback application 141 using the Internet or other network 120. Once the selection of the audio or video source, indicated in step 154, is completed, the audio or video playback application 141 verifies that the data source is available in step 153. If the data source is not available, then the system again awaits selection of the audio or video data source in step 154. If the data source is available or if the data source was originally selected and available when the play audio or video command 150 was initiated, then the audio or video playback application 141 checks to see if there is more data to be read from the data source in step 152. If there is no more data to be read from the data source as determined in step 152, then the audio or video playback application 141 is done playing the audio or video data as indicated in step 155. If there is more data to be read, as determined in step 152, then the audio or video playback application 141 reads data from the data source in step 156. The audio or video playback application 141 then checks if the audio or video decrypting and decoding peripheral 200 is ready for data in step 157. This check is repeated until the audio or video decrypting and decoding peripheral 200 is ready for data as indicated in step 157. Once the audio or video decrypting and decoding peripheral 200 is ready for data, the audio or video playback application 141 passes the data in step 158 to the audio or video decrypting and decoding peripheral 200. When passing of the data is complete, the audio or video playback application 141 then checks again if there is more data to be read in step 152. The process repeats until there is no more data to be read from the data source and the audio or video playback application 141 is done playing the audio or video data.

Peripheral Bus Interface Firmware Flow

Communication by the audio or video decrypting and decoding peripheral 200 with the computing platform 100 is handled by the peripheral bus interface 201. Though some functionality of the peripheral bus interface 201 may be embedded in hardware, the data flow and control is handled in firmware running on the peripheral bus interface 201 as shown in FIG. 7.

Referring to FIG. 7, when the peripheral bus interface 201 starts in step 230, which can occur when the audio or video decrypting and decoding peripheral 200 is powered or reset or when the peripheral bus interface 201 is reset, the firmware checks if there is data received in step 231 from the computing platform 100. If data has been received from the computing platform 100, the firmware passes the data in step 232 to the audio or video processor 202. After the data is passed to the audio or video processor 202 or if no data was received, as determined in step 231, the firmware checks if data has been received in step 233 from the audio or video processor 202. If data has been received from the audio or video processor 202, the firmware passes the data in step 234 to the computing platform 100. Once the data is passed to the computing platform 100 or no data was received, as determined in step 233, from the audio or video processor 202, the firmware checks if there is data received 231 from the computing platform 100. This process repeats until the peripheral bus interface 201 starts again.

Audio or Video Processor Firmware Flow

Within the audio or video decrypting and decoding peripheral 200, the audio or video processor 202 provides the audio or video data flow control 210, if necessary, with the computing platform 100. The audio or video processor 202 also handles decrypting and decoding processing 211 and audio or video playback timing generation 212. FIG. 8 provides the firmware flow diagram for the audio or video processor 202. When the audio or video processor 202 starts in step 220, which can occur when the audio or video decrypting and decoding peripheral 200 is powered or reset or when the audio or video processor 202 is reset, this firmware checks if there is data or status request received in step 221 from the computing platform 100. It is understood, as previously discussed, that communication between the audio or video processor 202 and the computing platform 100 goes through the peripheral bus interface 201. If there is data or status request received from the computing platform 100, then the firmware running on the audio or video processor 202 checks if there is a status request in step 222. If there is a status request, then the firmware running on the audio or video processor 202 sends the status information 223, which is likely to indicate that the audio or video processor 202 is ready for more data, to the computing platform 100. Once the status information is sent to the computing platform 100, the firmware running on the audio or video processor 202 checks if there is data or status request received as determined in step 221 from the computing platform 100, thus repeating the process. Otherwise, if there is not a status request, then it is assumed that encrypted or encoded audio or video data 133 is received from the computing platform 100. The data from the computing platform 100 is decrypted or decoded 224, as necessary. Then the firmware running on the audio or video processor 202, possibly in conjunction with hardware on the audio or video processor 202 or the audio or video digital to analog converter 206 or DAC, checks if it is time to pass the decrypted or decoded audio or video data 134 to the DAC 206 in step 225. If it is not time to pass the decrypted or decoded audio or video data 134 to the DAC 206, then the firmware running on the audio or video processor 202 keeps checking if it is time to pass the decrypted or decoded audio or video data 134 to the DAC 206. If it is time to pass the decrypted or decoded audio or video data 134 to the DAC 206, then the firmware passes in step 226 the decrypted or decoded audio or video data 134 to the DAC 206. The firmware then checks if there is data or status request received as determined in step 221 from the computing platform 100. This process repeats until the audio or video processor 202 starts again.

Secure Peripheral Schematics

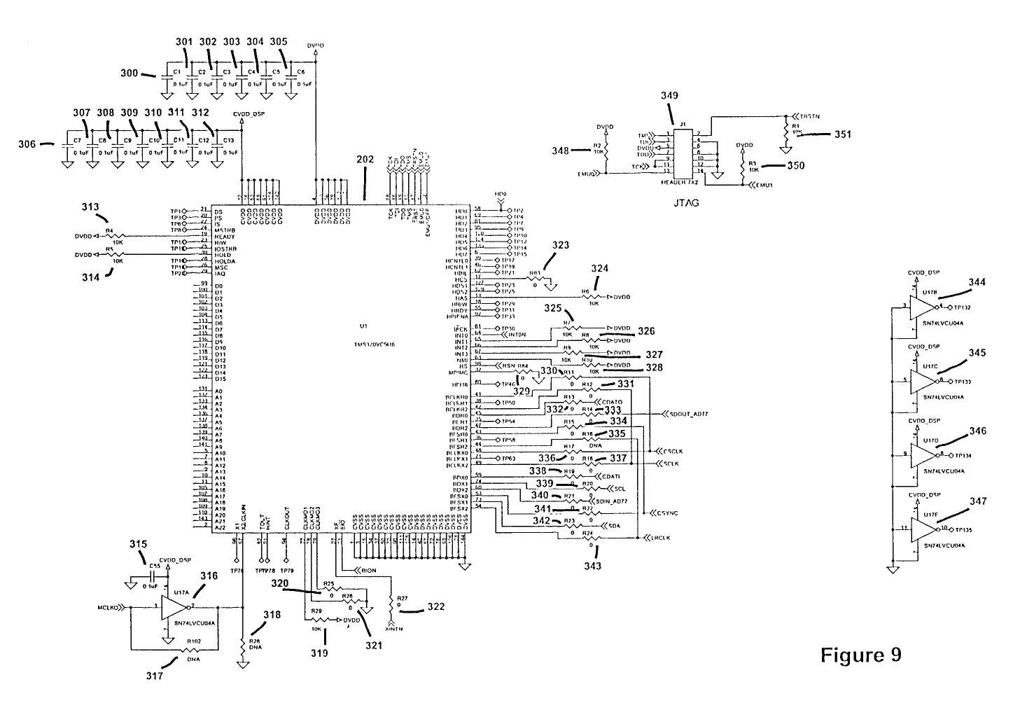

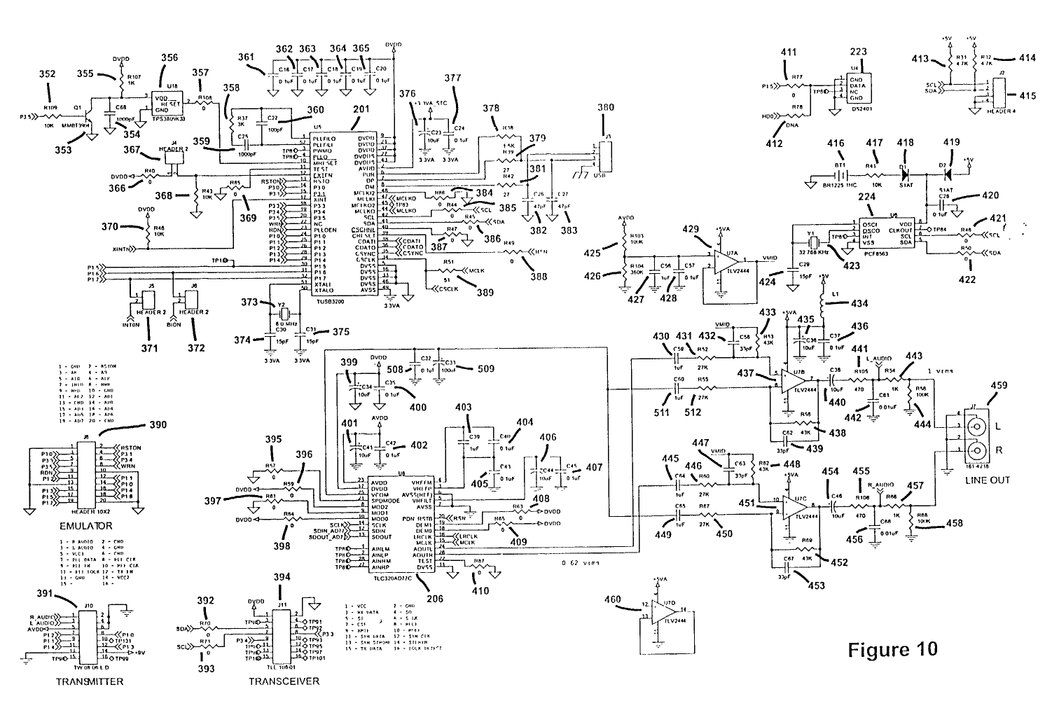

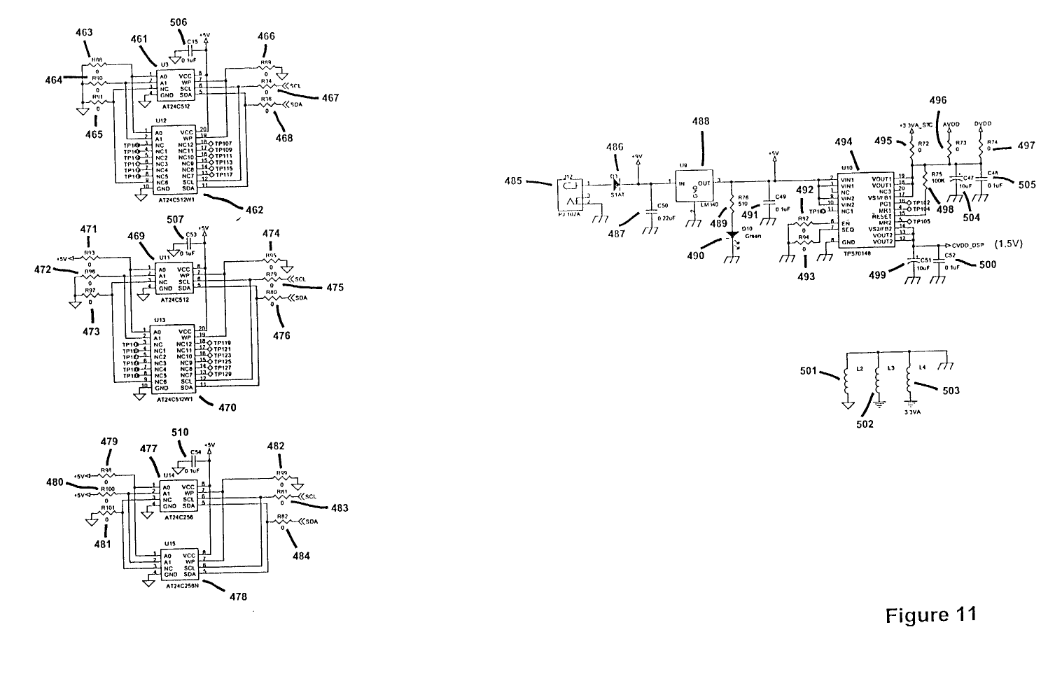

FIGS. 9 through 11 represent the schematic diagrams for an example implementation of a secure audio or video decrypting and decoding peripheral 200. This implementation example handles only audio decryption and decoding and generates analog audio for output. The secure audio or video decrypting and decoding peripheral 200 is also referred to as the base station 200 in this example.

A USB cable connects from the computing platform 100 to the base station 200 using a USB connector 380 on the base station 200. Signals from the USB connector 380 are applied to the peripheral bus interface 201, also referred to as a USB interface controller 201. The USB interface controller 201, may be a Texas Instruments TUSB3200. A plurality of resistors 378, 379, and 381 and capacitors 382 and 383 provide the proper loading and electrostatic protection on the USB signals from the USB connector 380. Another group of capacitors 361, 362, 363, 364, 365, 376, and 377 provide filtering for the power to the USB interface controller 201. A supply voltage supervisor 356, such as the Texas Instruments TPS3809, provides a software controlled reset of the USB interface controller 201, a feature useful after completing an update of the read only memory 203, or ROM, used to store firmware for the USB interface controller 201. A circuit consisting of a pair of resistors 352 and 355, a capacitor 354, and a transistor 353 complete implementation of the software controlled reset. Another resistor 357 is used to provide easier access to the reset signal from the supply voltage supervisor 356 for debugging. An oscillator 373 provides the clock for the USB interface controller 201 while a pair of capacitors 374 and 375 provide the loading required by the oscillator 373. A resistor 358 and a pair of capacitors 359 and 360 provide filtering for the phase locked loop, or PLL, inside the USB interface controller 201 that is used to generate additional clock signals. A resistor 389 is used to reduce noise on the master clock signal MCLK from the USB interface controller 201 to the digital to analog converter 206, or DAC. A plurality of resistors 366, 368, 369, 370, 384, and 387 are used to provide pull-ups to power or pull-downs to ground for various signals on the USB interface controller 201. Another group of resistors 385, 386, and 388 may be provided for easier access to various signals on the USB interface controller 201 for debug and the headers 367, 371, and 372 provide easy connection and disconnection of signals on the USB interface controller 201 for debug.

The USB interface controller 201 reads the code it executes from ROM 203 used to store USB interface controller firmware. One 256 kilobit serial ROM may be used for the design implementation. The design implementation supports two different packaging sizes for the serial ROMs, so either serial ROM 477 or 478 is included. A plurality of resistors 479, 480, 481, and 482 act as pull-ups to power or pull-downs to ground for various signals to the serial ROMs 477 and 478. Another group of resistors 483 and 484 are for debug purposes and provide easier debug access to the I²C bus signals used by the USB interface controller 201 to communicate with the serial ROMs 477 and 478. A bypass capacitor 510 provides filtering for power to the serial ROMs 477 and 478.

The audio processor 202 in this example may be Texas Instruments digital signal processor (DSP), model number TMS320VC5416. A plurality of bypass capacitors 300, 301, 302, 303, 304, 305, 306, 307, 308, 309, 310, 311, and 312 provide filtering on the interface and core power supplied to the audio processor 202 from the dual output voltage regulator 494. A plurality of resistors 313, 314, 319, 320, 321, 322, 323, 324, 325, 326, 327, 328, and 329 are used as pull-ups to power or pull-downs to ground for various signals on the audio processor 202. Another group of resistors 330, 331, 332, 333, 334, 335, 336, 337, 338, 339, 340, 341, 342, and 343 have no impedance and simply provide better debug access to the various signals going to and coming from the audio processor 202. Resistors 330, 331, 334, 335, 336, 337, 341, and 343 also allow for the selection of access to signals from one port or another on the audio processor 202, providing additional flexibility during debug of the design. An inverter 316 provides voltage level shifting of the clock signal to the audio processor 202, while a resistor 317 allows the voltage level shifting to be bypassed if it is not needed. The inverter 316 and the resistor 317, therefore, are mutually exclusive with only one or the other being placed on the circuit board. A capacitor 315 provides bypass capacitance on the power for the inverter 316. The audio processor 202 reads the code it executes from ROM 204 used to store DSP firmware. Two 512 kilobit serial ROMs may be used for the design implementation. The design implementation supports two different packaging sizes for the serial ROMs, so either serial ROMs 461 and 469 are included or 462 and 470 are included. A plurality of resistors 463, 464, 465, 466, 471, 472, 473, and 474 act as pull-ups to power or pull-downs to ground for various signals on the serial ROMs 461, 462, 469, and 470. A plurality of resistors 467, 468, 475, and 476 are for debug purposes and provide easier debug access to the I²C bus signals used by the audio processor 202 to communicate with the serial ROMs 461, 462, 469, and 470. Bypass capacitors 506 and 507 provide filtering for power to the serial ROMs 461, 462, 469, and 470.

The digital to analog converter 206, or DAC, is implemented in this example using the Texas Instruments TLC320AD77C. Power filtering, as well as filtering of the common voltage to the amplifiers 437 and 451 is handled by a plurality of capacitors 399, 400, 401, 402, 508, and 509. Filtering for the DAC reference voltage is provided by a plurality of capacitors 403, 404, 405, 406, and 407. A plurality of resistors 395, 396, 397, 398, 408, 409, and 410 provide pull-ups to power or pull-downs to ground for various signals on the DAC 206. The analog audio from the DAC 206 goes through filtering circuitry that provides a frequency band pass from roughly 20 Hz to 20,000 Hz. This band pass filtering circuitry includes operational amplifiers, or op amps, 429, 437, and 451, resistors 425, 426, 431, 433, 438, 441, 443, 444, 446, 448, 450, 452, 455, 457, 458, and 512, and capacitors 427, 428, 430, 432, 439, 440, 442, 445, 447, 449, 453, 454, 456, and 511. The filtered audio goes to the line level output connector 459. The inductor 434 and the capacitors 435 and 436 provide filtering on the power to the op amps 429, 437, and 451.

There are multiple voltage levels required by the different hardware sections in the base station 200. An external 9 to 12 volt power supply provides all power to the base station 200 and connects to the base station 200 through the power jack 485. A diode 486 provides a voltage drop and reverse polarity protection for the external power supply. A capacitor 487 provides filtering on the power from the external power supply. Since there are various voltage levels required in this specific implementation, there are multiple levels of voltage regulation. A voltage regulator 488 converts the voltage from the external power supply voltage to 5 volts. A light emitting diode, or LED, 490 provides visual feedback to the user that the base station 200 is successfully powered. A resistor 489 provides additional loading for the LED 490, to reduce the current going through the LED 490. A bypass capacitor 491 provides filtering on the 5-volt power from the voltage regulator 488.

Additional voltage levels are required in this base station 200 implementation example. For example, the first is 3.3 volts, which is used by components throughout the design. The other is a 1.5-volt core voltage for the specific audio processor 202 chosen for this design implementation. A dual output voltage regulator 494, which in this example is a Texas Instruments TPS70148, provides these two voltage levels. A plurality of capacitors 499, 500, 504, and 505 provide filtering on the power outputs from the dual output voltage regulator 494. Resistors 495, 496, and 497 are for debug purposes and allow removal of 3.3 -volt power to different sections in the design. A plurality of resistors 492, 493, and 498 act as pull-ups to power or pull-downs to ground for various signals on the dual output voltage regulator 494. Multiple ferrite beads 501, 502, and 503 are used to provide noise filtering and isolation between the various ground planes in the base station 200 design.

The unique ID 223 is implemented in this example using the Dallas Semiconductor DS2401. The unique ID 223 has a single pin serial interface that can be connected to the USB interface controller 201 through a resistor 411 or to the audio processor 202 through a resistor 412. The real-time clock 224 is implemented in this example using the Philips Semiconductor PCF8563. The real-time clock 224 communicates on the I²C bus with the USB interface controller 201, with a pair of resistors 421 and 422 providing easier debug access to the I²C bus clock and data signals. Power to the real-time clock 224 is normally provided from the 5-volt regulator 488. When the external power supply is not available, the battery 416 provides power to the real-time clock 224 in order to maintain the correct time. A diode 418 prevents the 5-volt power from charging the battery 416 and diode 419 prevents the current from the battery 416 from leaking into the 5-volt power circuit. A resistor 417 provides additional loading in case the diode 418 fails. A bypass capacitor 420 provides filtering on the power to the real-time clock 224. An oscillator 423 provides a timing count for the real-time clock 224, while the capacitor 424 provides a load as required by the oscillator 423.

A connector 349 is used for connection to an external JTAG emulator. The JTAG interface connects to the audio processor 202 and is used for debugging of code running on the audio processor 202. A plurality of resistors 348, 350, and 351 are used to pull-up to power or pull-down to ground certain signals on connector 349 that go to the audio processor 202 in case the JTAG emulator is not connected. The connector 349 may be removed for production. Another connector 390 may be used for connection to an external 8051 emulator. The 8051 emulation interface connects to the USB interface controller 201 and is used for debugging of code running on the USB interface controller 201. The connector 390 is not used for production. Another connector 415 provides easy debug access to the clock and data signals on the I²C bus, which is used by the USB interface controller 201 or audio processor 202 to access peripherals such as the real-time clock 224, USB firmware ROM 203, and DSP firmware ROM 204. Another connector 415 will be removed for production. A plurality of resistors 413 and 414 are used as pull-ups to power for the I²C bus clock and data signals. Inverters 344, 345, 346, and 347 are not used, but are within a part that is being used. An op amp 460 is not used, but is within a part that is being used. In addition, resistor 318 is not used and is not placed on the circuit board.

Another connector 394 on the base station 200 provides connection to an optional external module, which is not described here. A pair of resistors 392 and 393 are for debug purposes and provide easier debug access to the I²C bus signals used by the USB interface controller 201 to communicate with the optional external module. Connector 391 on the base station 200 provides connection to another optional external module, which is also not described here.

Obviously, many modifications and variations of the present invention are possible in light of the above teachings. Thus, it is to be understood that, within the scope of the appended claims, the invention may be practiced otherwise than as specifically described above.

What is claimed and desired to be covered by a Letters Patent is as follows:

We claim:

1. A secure architecture for encoded or encrypted digital audio files comprising:
a computing platform for processing encrypted or encoded digital data, said computing platform including a peripheral bus and configured to run audio or video playback application software and pass said encrypted or encoded digital data to said peripheral bus configured so as to be not-accessible by said audio or video playback software;
a peripheral coupled to said peripheral bus configured to decrypt or decode said encrypted or encoded digital data and generate a decoded or decrypted output signal.
